(19) United States
(12) Patent Application Publication
(10) Pub. No.: US 2010/0308234 A1
(43) Pub. Date: Dec. 9, 2010

(54) Improved Measurement System and Method

(75) Inventors: Raimo Harju, Turku (FI); Petri Kivelä, Turku (FI); Jyrki Laitinen, Turku (FI); Pauli Salmelainen, Turku (FI); Jarkko Sarmaala, Turka (FI)

Correspondence Address: Seppo Laine Oy;Joshua P. Wert, Itamerenkatu 3B, Helsinki, FI00180, FI

(73) Assignee: Wallac OY, Turku (FI)

(21) Appl. No.: 12/739,146

(22) PCT Filed: Jan. 23, 2009
(86) PCT No.: PCT/FI09/50058

§ 371 Date: Apr. 22, 2010

Related U.S. Application Data
(60) Provisional application No. 61/006,660, filed on Jan. 25, 2008.

(30) Foreign Application Priority Data
Jan. 25, 2008 (FI) 20085062

(51) Int. Cl. G01N 21/64; G01J 3/12

(52) U.S. Cl. 250/458.1; 356/332; 356/333

(57) ABSTRACT

The invention concerns a measurement system and method for optical spectroscopic measurement of samples. The system comprises an illumination source for forming a primary light beam, a first tunable monochromator for spectrally filtering the primary light beam, a sample-receiving zone to which the spectrally filtered primary beam is directed for producing a secondary light beam affected by a sample in the sample receiving zone, and a second tunable monochromator for spectrally filtering the secondary light beam, and a detector for measuring the intensity of the spectrally filtered secondary beam. In particular, the system is adapted to scan a predefined wavelength range using one of the monochromators and to tune the other monochromator sequentially to one of at least two predefined separate wavelengths in order to eliminate the effect of undesired diffraction orders of the second monochromator on the measurement. The invention allows for eliminating the use of optical diffraction order filters on the emission side of a fluorescence measurement system.

### BACKGROUND OF THE INVENTION

The invention relates to optical measurement of samples. In particular, the invention concerns systems and apparatuses for measurement of fluorescent light originating from a sample which is located in a sample container, such as a microtiter plate.

Sample measurement systems of the present kind typically comprise two main sub-systems which are hereinafter called the excitation side and the emission side. The function of the excitation side is to provide primary light (also: excitation light), which is directed to the sample. Before directing, the light beam is spectrally filtered using a conventional optical filter (also referred herein as optical transmission filters), a monochromator or both in order to provide a light beam having desired spectral properties to the sample. The function of the emission side is to collect and detect secondary light (also: emission light) influenced by or originating from the sample (e.g., fluorescent light in the case of fluorescence measurement apparatuses such as spectrofluorometers). The possibility for spectral filtering is typically provided at the emission side too for enabling selection of the wavelength or wavelength range of interest in the analysis in concern.

Fluorescence is typically measured by directing to a sample a narrow-band excitation signal and detecting the response of the sample to the excitation. In practice, the sample contains label molecules, which absorb the excitation light and subsequently emit light at generally longer wavelengths.

Typical commercial spectrofuorometers are capable of measuring both the excitation spectrum and emission spectrum of a sample. The excitation spectrum is measured by reading emission at a fixed wavelength and scanning the excitation wavelength over the desired range of wavelengths. Correspondingly the emission spectrum is measured by using a fixed wavelength excitation light and detecting the fluorescence spectrum for example by scanning over the desired range of wavelengths.

If the capability of continuous scanning of wavelengths is desired, fixed optical narrow-band filters can not be used. Instead of that, scanning monochromators can be used for allowing convenient wavelength-selection. In a monochromator, light is generally diffracted from a grating surface in order to produce a continuous, dispersed spectrum of light. From the continuous spectrum, a distinct wavelength band is selected by means of a slit having a certain physical width. For achieving a sufficiently narrow band of light, double monochromators, i.e. two monochromators coupled in tandem such that the dispersion effect is added, have previously been used. U.S. Pat. No. 6,654,119 and US 2005/0,030,607 describe known apparatuses of the types described above.

Monochromators have the disadvantage that diffraction gratings used in them pass light to the output of the monochromator at several distinct partly overlapping diffraction orders, from which only one diffraction order is typically desired. That is, a monochromator intended to let light pass at its output for example at a wavelength of 1000 nm, also the wavelengths of 250 nm, 333 nm and 500 nm are passed. Therefore light having not only the desired wavelength but also other wavelengths is conveyed to the output of the monochromator, and further to the sample or the detector, depending on which side of the system the monochromator is. Therefore, in a usual configuration, optical filters are inserted in the optical path to block the undesired diffraction orders. Such filters, however, cause optical losses, which may amount at least to about 10 intensity-%, with conventional lens optics typically to 30 intensity % and even more. In a generic instrumentation, there is also a need for a plurality of such filters in order to be able to block all undesired diffraction orders, depending on the prevailing/desired characteristics of the input/output light. These filters are referred to as “blocking filters” hereinafter.

In applications requiring high sensitivity a photomultiplier tube (PMT) is used as a detector for sample-influenced light, e.g. fluorescent emission light. As PMTs as such are not capable of wavelength discrimination, a tunable monochromator—and therefore also blocking filters—are typically provided also on the emission side of the apparatus.

U.S. Pat. No. 4,957,366 discloses a method for fording emission and excitation maxima in fluorescence measurements, when the sample is such that the signal level is very low and second order scattering peak of excitation light or the Raman peak of the sample may be more intense than the fluorescence signal. However, in fluorescence measurements from microtiter plates and the like containers, the signal caused by the reflection from the sample is larger than the scattering signal.

### SUMMARY OF THE INVENTION

The aim of the present disclosure is to provide an improved optical measurement system/apparatus and method.

The present system/apparatus basically comprises
an illumination source for forming a primary light beam,
a sample-receiving zone to which the primary light beam is directed for producing a secondary light beam affected by a sample in the sample receiving zone, and
at least one scanning monochromator for spectrally filtering, ie. selecting a desired band for, the primary and/or secondary light beam to be targeted to the sample and/or detector, respectively, and
a detector for measuring at selected wavelengths of the secondary light beam.

In particular, tumble monochromators, ie. monochromators capable of scanning over a desired band, may be provided for spectrally filtering both the primary and the secondary beams.

In the present method
a primary light beam is produced,
the primary light beam is directed to a sample in order to produce a secondary light beam affected by the sample,
the primary and/or the secondary light beam is spectrally filtered by means of a scanning monochromator, and
the secondary light beam is collected and at least a selected wavelength band of the secondary light beam is detected.

One particular aim of the present disclosure is to provide an apparatus and method in which the need for a blocking filter on the emission side of the device is eliminated.

This aim is achieved by scanning a predefined wavelength range using one of the monochromators, depending on the measurement mode, and tuning the other monochromator sequentially to one of at least two predefined separate wavelengths. This allows for eliminating the light at undesired diffraction orders to affect the spectrum measurements.

In detail, when measuring excitation spectrum, this is achieved by measuring the secondary light beam at least two separate wavelengths for eliminating the effect of undesired diffraction orders on the measurement as the scanning monochromator on the excitation side is tuned over a desired wavelength range. When measuring excitation spectrum, the is achieved by exciting the sample at least two separate wavelengths for eliminating the effect of undesired diffraction orders on the measurement as the scanning monochromator on the emission side is scanned over a desired wavelength range.

As a general rule, the separate wavelengths are chosen such that they overlap with the emission/excitation peak of the sample concerned, but are sufficiently apart from each other such that the diffraction orders not describing the properties of the sample, but the measurement system itself, can be “jumped over”. Thus, the selected wavelengths must allow for a continuous emission/excitation spectrum to be constructed. The wavelength separation is typically at least 10 nm, in particular 30-100 nm, typically about 50 nm depending on bandwidth

According to one embodiment, the apparatus is adapted to measure the intensity of the spectrally filtered secondary beam piecewise using successively said separate wavelengths during said scanning. That is, the spectrum is scanned only once and, at appropriate positions, the other monochromator is tuned such that wavelengths not originating from the sample and reaction concerned, is passed to the detector. According to an alternative embodiment the apparatus is adapted to measure the intensity of the spectrally filtered secondary beam at both said separate wavelengths at the whole wavelength range. Thus, two scans are needed. From both measurements, one is able to reconstruct a continuous emission or excitation spectrum of the sample from the measured light intensity.

The concept of using two or more separate excitation or emission wavelengths provides significant advantages. Thus, the need of a blocking filter on the emission side of the device is eliminated. The detection of undesired diffraction order peaks, and thus possible saturation of detection, can be circumvented in a practical way. As there is no need for filter-based diffraction order blocking, no attenuation of light takes place and the equipment costs may be reduced. As blocking filters may decrease the signal level by at least 10%, in typical optical configurations even 30% or more, measurement sensitivity is increased. In some measurements, the signal levels are so low that using a blocking filter is practically impossible. Also device space and manufacturing costs are saved.

Depending on the emission wavelengths chosen, the detected piecewise spectra may require normalization in order for the results obtained at said wavelength to be commensurate. A more detailed example of this kind of measurement is provided later is this document.

One aim of the present disclosure is to provide an apparatus, in which the amount of stray light passing the monochromators and further to the detector is reduced.

To achieve this goal, a double monochromator of subtractive type can be used. Thus, according to one aspect, the monochromator(s) on the emission and/or the excitation side is/are substractive double monochromator(s). By a “subtractive” double monochromator is meant a coupling of two elementary monochromators in such a way that the second monochromator at least partly cancels the dispersive effect of the first monochromator on a narrow band, i.e. on the band that has passed from the first monochromator to the second monochromator. That is, in the second monochromator the angular spreading of wavelengths in the pass-band of the first monochromator is annulled. A substantially spatially homogeneous light beam therefore exits from the double monochromator. This is in contrast to the conventional additive coupling scheme of monochromators, in which the dispersions of the single monochromators are summed.

The use of subtractive double monochromators provides considerable advantages. Thus, the stray light level of the excitation and/or the emission monochromator can be reduced in relation to the total intensity of light exiting the monochromator(s). This is because a narrower slit can be used and therefore the stray light from the first diffraction surface of the double monochromator is blocked more effectively. However, because the subtractive functional coupling of the second diffraction surface, the amount of light having the desired wavelength is not reduced by the same ratio. That is, the usable light signal to stray light ratio is increased.

According to one embodiment the width of the slit between the first and second gratings in one or both of the double monochromators is adjustable. Typically the width of the slit is adjustable or the slit is rotatable about an axis perpendicular to the path of light for allowing on-line selection of the bandwidth.

The conventional additive coupling of monochromators, which is also possible in some embodiments of the present system, has the benefit that a very narrow band of light is passed through and therefore a relatively good spectral resolution of the measurement can be achieved. However, in many applications minimizing the pass-band of the excitation monochromator is not necessary. That is, although the width of the pass-band is may be slightly compromised by using subtractive monochromators, the advantages of lowering the amount of stray light is more significant is some applications.

The excitation side of the apparatus generally comprises a blocking filter for eliminating entry of light at undesired diffraction orders of the first (double) monochromator to pass to the sample.

If the above described two-wavelength “program-based blocking” of diffraction order is not utilized also the emission side is typically be provided with a blocking filter. As an interesting option, linear variable interference filter in contrast to a conventional broadband filter or a prism may be used, in particular on the emission side of the apparatus.

According to a particular embodiment, a blocking filter is provided at the location of the intermediate slit which saves device space.

Compared with high quality optical filters, one unavoidable drawback of monochromators, independent of their type, is that they pass more stray light through outside the desired pass band. In particular when using monochromators for both an excitation side and an emission side the increased stray light causes some problems, if the optics is made in a traditional way in plate readers where the sample is excited above and also the emission light is collected above the sample. This is because when the liquid sample is excited, a small fraction of the excitation light is reflected from its surface. Because monochromators have worse stray light blocking level than filters, this reflected excitation light passes the emission monochromator more easily and increases background level of the emission signal.

This problem can be efficiently solved by tilting the excitation channel so that the reflected excitation light will not strike the emission channel. A particularly efficient solution is achieved by tilting both the excitation and emission channels with respect to the sample surface. As the emission and excitation channels, i.e., the optical excitation path and the emission light collection path, have different planes of incidence, the amount of light reflected from the surface of the sample and hitting the detector is reduced.

However, even in that case a problem remains that the focus of the excitation beam and the focus of the collection optics have to coincide inside the sample near the surface of the sample, with good accuracy. Otherwise, signal level is decreased.

This further problem can be solved by the following arrangement:
the excitation beam is directed to the sample from above the sample and along a primary optical path and the emission beam is collected from the sample along a secondary optical path which is inclined with respect to the primary optical path,
common plane of primary and secondary optical paths is also inclined to the normal of sample surface, and
the apparatus comprises at least one optically eccentric rotatable member assembled on the primary or secondary optical path or both for adjusting the mutual positions of the primary and secondary optical paths.

The eccentric rotatable member typically comprises a sleeve rotatable mounted to a support. An optical fiber is eccentrically mounted to the sleeve such that its position with respect to the support, and thus the position of the focus point of the respective optical channel, can be changed by rotating the sleeve.

### BRIEF DESCRIPTION OF THE DRAWINGS

Next, embodiments of the invention are described in more detail with reference to the appended drawings.

FIG. 1 shows an exemplary apparatus configuration at system level.

FIG. 2 illustrates an embodiment of a measurement head for microtiter plates.

FIGS. 3a-3d show graphs relating to blocking-filter free measurement.

### DETAILED DESCRIPTION OF EMBODIMENTS

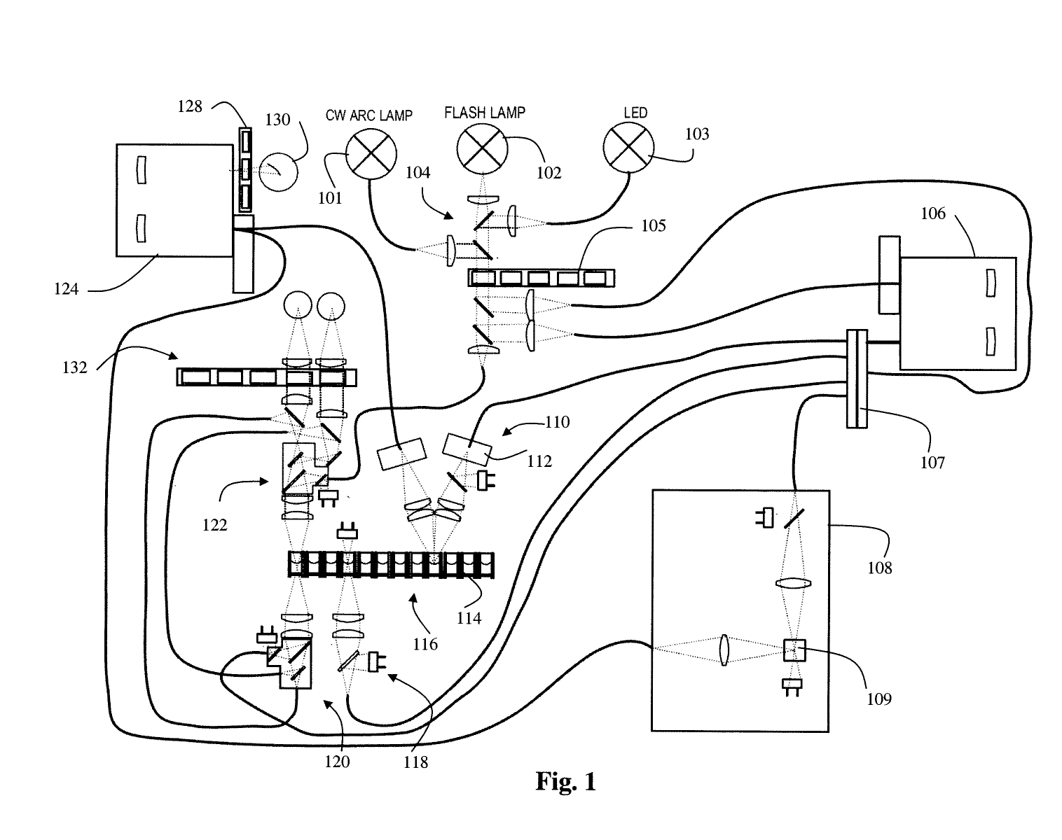

With reference to FIG. 1, the illumination source on the excitation side of the apparatus may comprise one or more of the following individual light sources: a broadband continuous-wave light source 101, a pulse-mode light source 102; a fixed-wavelength or tunable laser; a multiple-unit narrow-bandwidth source 103, such as multiple-LED source in which the wavelength regions of the LEDs overlap. A more detailed description of the illumination unit source can be found in the patent application FI 20075772, the contents of which are incorporated herein by reference.

Light is guided from the light source using selector optics 104, optionally through an optical transmission filter 105, to a first monochromator 106. It is to be noted that the system of FIG. 1 allows for a plurality of other measurement techniques also, for example, to guide light directly, i.e., without monochromatization, to a microtiter plate 114 from above or below using appropriate optical selectors, fibers and measurement heads 110, 122, 118 and 120. Light can typically be guided to all of some of these measurement heads also through the monochromator 106. For aiding flexible selection of the measurement mode, the selector optics 104 and/or a light switch 107 can be used, as shown in the FIG. 1. The light switch basically allows for one of a plurality of inputs to be coupled to one of a plurality of outputs. The operation of the light switch is described more closely in the patent application FI 20075773, the contents of which are incorporated herein by reference. The measurement optics may follow the principles set out in the patent application US 2003/0048446 (now U.S. Pat. No. 6,822,741). In particular, there may be provided at least modular measurement head having a plurality of light inputs.

In a particular embodiment, a multiple-LED light source is used together with subtractive excitation monochromator in fluorescence measurements. LEDs intrinsically provide efficient elimination of undesired wavelengths and the monochromator ensures low amount of stray light.

If a multiple-LED light source is utilized, the need for a blocking filter can be eliminated also from the excitation side of the device, as the initial primary light is of narrow bandwidth.

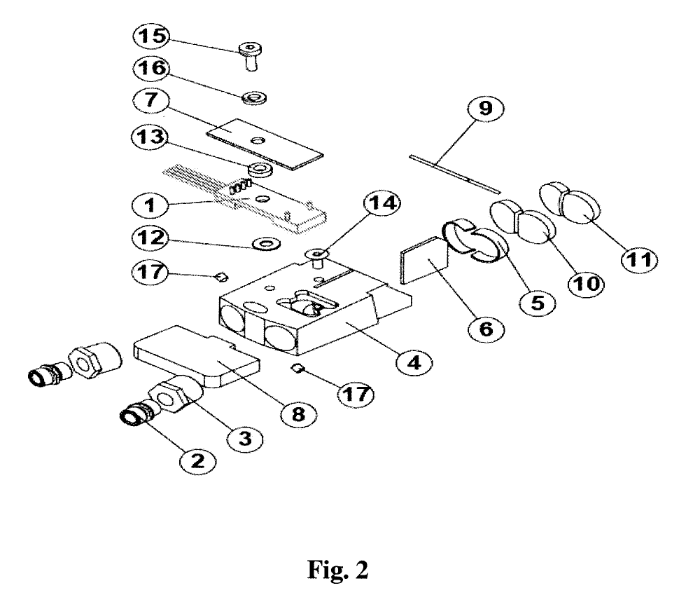

According to one embodiment, there is provided a measurement head 110 in which the excitation and emission channels are tilted with respect to each other and separated as far as optical reflections from the sample or microtiter plate are concerned. FIG. 2 shows a measurement head, which can be used for this purpose. The head comprises segmented lenses 10, 11 in order to make the excitation and emission channels closer to each other. Because space in the vertical direction in apparatuses of the present kind are typically limited, lens frame 4 can be aligned horizontally and at the end of the frame 4 there may be a mirror at an inclined, for example, 35 to 55 degree angle. With this kind of design the focal point is close enough of the lower surface of the lens frame. Because the excitation and emission channels are separated, neither of the channels is exactly above the sample well, but instead of that, the channels are symmetrically around a vertical plane through middle point of the sample well. In addition both the channels are also tilted so that plane formed by optical axes of the excitation and emission channels goes through the sample surface at about 10 degree angle. This angle causes the reflected excitation light to be directed away from the emission channel Exact positioning of the excitation and emission channels is achieved by using optically eccentric rotatable members 3 assembled on the channels. The excitation and emission optical fibers are connectable to the rotatable members through connection members 2. The purpose of this arrangement is to compensate any manufacturing tolerances of the rest of the measurement head and to allow for the optical axes of the excitation and emission signals to exactly coincide within the sample for maximizing the measurement sensitivity.

It is to be noted that when the instrument is based for monochromators, it is not desirable to use a dichroic mirror to separate the excitation and emission light. This is because monochromators are often used for scanning measurements over a wide wavelength range and dichroic mirrors will not work properly in this kind of use. It would be possible to use a mirror which reflects 50% and transmits 50% of the light, but this kind of mirror immediately loses 50% of the excitation light and 50% of the emission light and therefore the measured signal is reduced by 75%. However, if the excitation and emission channels are totally separated, as in the present configuration, there is no need for a beam splitter between the excitation and emission light.

The emission light is guided through an optical fiber to a second monochromator 124. In the second monochromator 124, the desired wavelength for detection is selected. For blocking undesired diffraction orders, a blocking filter bank 128 may be used before or after the monochromator or inside the monochromator. The blocking filter bank may comprise, for example, conventional low- or high-pass filters or one or more interference filters of appropriate characteristics. The required filter can be chosen by sliding or rotated movement of the filter bank 128. Alternatively, the two-wavelength measurement disclosed herein can be used for avoiding the use of blocking filters. Thus, the emission detection can also be carried out by a detector directly coupled to the emission monochromator. This means that no emission filtering optics, other than possibly an optical fiber, is provided between the output of the emission monochromator and the detector.

According to one aspect, the detector 130 is a photomultiplier tube. However, if maximum sensitivity is not required, solid-state detectors may also be employed.

For holding the microplate 114 comprising a plurality of sample wells the apparatus typically comprises a microplate holder which is movable with respect to the measurement head 110 optics for allowing measurement of all of the sample wells successively. In addition to a microplate holder, the apparatus may comprise a cuvette holder 108 for receiving a single-sample cuvette 109, and optical means for directing excitation light to and for collecting emission light from the cuvette instead of the microplate, at the option of the user of the apparatus. The selection of the measurement target can also be made using the selector optics 104 and the light relay 107. The apparatus typically comprises a direct optical emission light path from the cuvette holder 108 to the second monochromator 124.

The presently disclosed apparatus configuration can be used, for example, in fluorescence measurements (including traditional, time-resolved and polarisation fluorescence techniques), phosphorescence, and photometry. The apparatus is also, without substantial modification, suitable for chemiluminescence measurements, provided that only the emission side of the apparatus is used and suitable initiation means are provided for starting the luminescence reaction.

Returning now back to the aspect of avoiding optical diffraction order blocking on the emission side, a more detailed description is given. In excitation spectroscopy mode, that is, when the excitation spectrum of the sample is scanned, the measurement may comprise
scanning the excitation beam, by tuning the first (double) monochromator 106, from a low wavelength towards a higher wavelength and measuring at a higher of two predefined separate wavelengths by appropriate tuning of the second monochromator 124,
before an undesired diffraction peak, which otherwise would pass the second monochromator, is reached, measuring at the lower of the separate wavelengths is begun and scanning is continued with the first (double) monochromator 106,
in order to obtain a complete spectrum, measuring, after the undesired diffraction order has been passed, again at the higher of the separate wavelengths and continuing scanning.

The same procedure may be performed for other undesired diffraction orders too.

In the emission spectroscopy mode, the same is performed using the monochromators vice versa, that is
scanning the emission light wavelength, by tuning the second (double) monochromator, from a low wavelength towards a higher wavelength and exciting the sample at a higher of two predefined separate wavelengths,
before an undesired diffraction peak is reached, exciting the sample at the lower of the separate wavelengths is begun and sweeping is continued,
for obtaining a more complete spectrum, the excitation is switched back to the higher of the separate wavelengths and sweeping is continued.

In more detail, scanning of the emission spectrum may comprise:
selecting a first excitation wavelength EX1 and a second excitation wavelength EX2 (for example 300 nm and 350 nm, respectively),
using EX1 for excitation, scanning first parts of the emission spectrum (for example 320-580 nm and 620-880 nm),
using EX2 for excitation, scanning second parts of the emission spectrum (for example 370-680 nm and 720-1000 nm), and
calculating, using all said parts, the whole emission spectrum (ie. 320-1000 nm).

Naturally, even more separate excitation or emission wavelengths can be used for the piecewise detection.

The system typically comprises a control unit having suitable means for carrying out the necessary adjustments of the monochromators. In addition, there may be a memory, functionally connected to the control unit for storing and utilizing at least the separate wavelengths and the measured spectrum or spectra.

According to a particular embodiment, the present method is carried out such that the emission wavelength at all times is less than two times the excitation wavelength minus a predefined tolerance wavelength or more than two times the excitation wavelength plus a predefined tolerance wavelength. The tolerance wavelength can be, for example 10-30 nm (20 nm in the above example).

The separate wavelengths may be automatically determined depending on the properties of the sample or they may be entered by the user. According to a particular embodiment, both the separate wavelengths are predetermined, that is, stored in to system memory, before the measurement begins. Typically they are chosen from different sides of the peak value of the excitation or emission peak of the sample. However, it has to be ensured, that the wavelengths overlap with the respective peak, i.e., that the signal level does not go to zero. Using typical samples and label molecules, a suitable separation of the wavelengths is 50+/−20 nm. According to one aspect, the excitation or emission peak has approximately the same amplitude (e.g., within 20%) at each of the separate wavelengths.

The measurement results obtained using the separate wavelengths are combined using a software-controlled microprocessor in order to form a single continuous spectrum. This may be carried out by an integrated computing unit or by a separate computing means to which the measurement data is transferred.

As already referred to above, at least one of the double monochromators may be a subtractive double monochromator. Such a monochromator typically comprises
an input aperture for light,
a first diffractive grating for producing a first diffraction pattern,
a second diffractive grating adapted to subtractively diffract portion of the first diffraction pattern in order to produce a second diffraction pattern, and
a intermediate slit between the first and second diffractive gratings for selecting the bandwidth of light passing to the second diffractive grating.
an output aperture for light spectrally limited/filtered by the gratings and the slit.

It has been observed that the intermediate slit, when configured to be adjustable, may serve as the only regulator of signal bandwidth in particular on the emission side of the device. It is also possible to place a blocking filter, if used at all, in the vicinity of the slit, that is, within the double monochomator.

Light guidance within the device is primarily performed using optical fibers.

According to one aspect, there is provided an optical fiber bundle at the output of at least one of the subtractive double monochromator contained in the device. As subtractive monochromators provide homogeneous light instead of dispersed light to their output, all the fibers of the fiber bundle obtain light having the same spectral characteristics. This opens interesting opportunities for apparatus design as beam splitting can be made directly at an output of a monochromator or optical fiber designs having special characteristics can be employed.

The apparatus typically comprises an integral processor for controlling the measurement modes, temporal flows of measurements and, optionally, for analyzing the data measured.

### Example 1

### Program-Based Diffraction Order Blocking

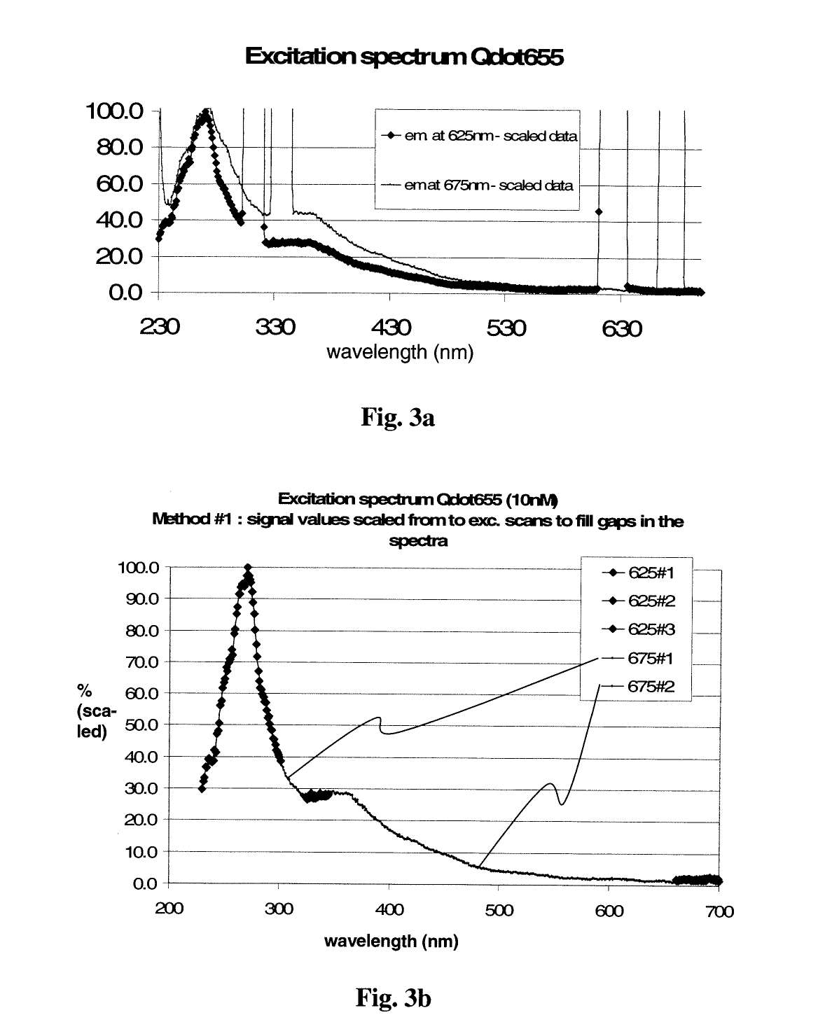

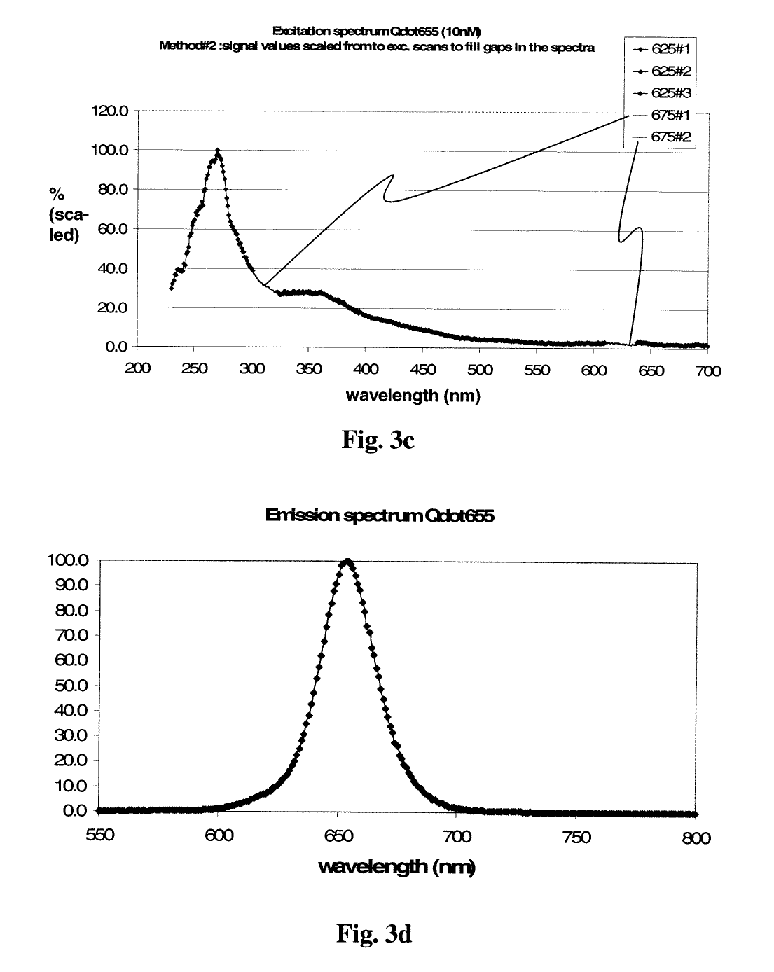

FIGS. 3a-3d illustrate exemplary measurement results obtained using the two-wavelength measurement technique described above. The Qdot label used in the experiments is a product and trademark of Invitrogen Corporation.

In FIG. 3a, excitation spectra of Qdot655 obtained using emission detection wavelengths of 625 nm and 675 nm are shown. The discontinuities caused by undesired diffraction orders are clearly visible as saturation of the measurement. However, it must be noted that the regions of discontinuity do not overlap.

FIGS. 3b and 3c show reconstructed excitation spectra of Qdot655 using two different methods falling within the present disclosure. Parts measured using different emission wavelengths are indicated.

FIG. 3d shows an emission spectrum of Qdot655 using the present piecewise emission spectrum measurement method. The measured spectrum corresponds well with the reference spectrum.

The embodiments described above and in the figures are not limiting and can be freely combined within the scope of the present disclosure and in particular within the scope of the attached claims.

1. A measurement system for optical spectroscopic measurement of samples, comprising
an illumination source for forming a primary light beam,
a first tunable monochromator for spectrally filtering the primary light beam for producing a spectrally filtered primary beam,
a sample-receiving zone to which the spectrally filtered primary beam is directed for producing a secondary light beam affected by a sample in the sample receiving zone, and
a second tunable monochromator for spectrally filtering the secondary light beam for producing a spectrally filtered secondary beam, and
a detector for measuring the intensity of the spectrally filtered secondary beam,
wherein the measurement system is adapted to
scan a predefined wavelength range using one of the monochromators and to tune the other monochromator sequentially to at least two predefined separate wavelengths in order to eliminate the effect of undesired diffraction orders of the second monochromator on the measurement.

2. The measurement system according to claim 1, which is adapted to measure the intensity of the spectrally filtered secondary beam piecewise using successively said separate wavelengths during the scanning.

3. The measurement system according to claim 1, which is adapted to measure the intensity of the spectrally filtered secondary beam at both said separate wavelengths at the whole wavelength range.

4. The measurement system according to claim 1, which is adapted to reconstruct a continuous emission or excitation spectrum of the sample from the measured light intensity.

5. The measurement system according to claim 1, which is adapted, in excitation spectroscopy mode, to
scan the spectrally filtered primary beam, by tuning the first monochromator, from a low wavelength towards a higher wavelength and measuring at the higher of the separate wavelengths,
before an undesired diffraction peak is reached, begin measuring at the lower of the separate wavelengths and continue scanning,
optionally, begin again measuring at the higher of the separate wavelengths and continue scanning.

6. The measurement system according to claim 1, which is adapted, in emission spectroscopy mode, to
scan the spectrally filtered secondary beam, by tuning the second monochromator, from a low wavelength towards a higher wavelength and exciting the sample at the higher of the separate wavelengths,
before an undesired diffraction peak is reached, begin exciting the sample at the lower of the separate wavelengths and continue sweeping,
optionally, begin again exciting the sample at the higher of the separate wavelengths and continue scanning.

7. The measurement system according to claim 1, wherein said separate wavelengths are automatically determined depending on the properties of the sample or can be entered by the user

8. (canceled)

9. The measurement system according to claim 1, wherein the illumination source comprises a plurality of individual narrow-band light sources, such as LEDs, having overlapping emission bands, one of the individual narrow-band light sources at a time being selectable for producing said primary light beam.

10. The measurement system according to claim 1, wherein at least one of the monochromators is a double monochromator.

11. The measurement system according to claim 10, wherein at least one of the double monochromators is a subtractive double monochromators.

12. The measurement system according to claim 11, wherein at least one of the subtractive double monochromator comprises
an input aperture for light,
a first diffractive grating for producing a first diffraction pattern,
a second diffractive grating adapted to subtractively diffract portion of the first diffraction pattern in order to produce a second diffraction pattern, and
a intermediate slit between the first and second diffractive gratings for selecting the bandwidth of light passing to the second diffractive grating.
an output aperture for light spectrally filtered by the gratings and the slit.

13. The measurement system according to claim 12, wherein the width of the intermediate slit is adjustable or wherein the intermediate slit is rotatable about an axis perpendicular to the path of light beam for allowing on-line selection of the bandwidth.

14. The measurement system according to claim 1, wherein the optical path from the sample to the detector is free from optical transmission filters.

15. The measurement system according to claim 1, wherein the spectrally filtered primary beam is directed to the sample from above the sample and along a primary optical path which is in inclined angle with respect to the normal of the surface of the sample.

16. The measurement system according to claim 15, wherein the secondary beam is collected from above the sample and along a secondary optical path, the plane defined by first and the second optical paths being inclined with respect to the normal of the surface of the sample.

17. The measurement system according to claim 15 or 16, wherein the exact positions of the primary optical path and/or the secondary optical path on the sample are adjustable by means of at least one optically eccentric rotatable member assembled on the primary or secondary optical path or both.

18. The measurement system according to claim 17, wherein said at least one optically eccentric rotatable member comprises a rotatable member to which an optical fiber, serving to guide the spectrally filtered primary beam or the secondary beam, is connected eccentrically.

19. The measurement system according to claim 1, which comprises
a microplate holder for receiving a microplate comprising a plurality of sample wells, and
optical means for directing spectrally filtered primary light to and for collecting secondary light from the sample wells of the microplate,
wherein the microplate holder and the optical means are movable with respect to each other for allowing measurement of all of the sample wells successively.

20. The measurement system according to claim 19, which further comprises
a cuvette holder for receiving a sample cuvette, and
optical means for directing spectrally filtered primary light to and for collecting secondary light from the cuvette instead of the microplate, at the option of the measurement system.

21. The measurement system according to claim 1, which is adapted for fluorescence measurements.

22. A method for optical measurement of samples, comprising
producing a primary light beam,
spectrally filtering the primary light beam using a first scanning monochromator for producing a spectrally filtered primary beam,
directing the spectrally filtered primary beam to a sample,
collecting secondary light from the sample,
spectrally filtering the secondary light using a second scanning monochromator for producing a spectrally filtered secondary beam, and
a detecting the intensity of the spectrally filtered secondary beam,
wherein
a predefined wavelength range is scanned using one of the monochromators, and the other monochromator is alternatatingly tuned to at least two separate wavelengths for eliminating the effect of undesired diffraction orders of the second monochromator on the measurement.

23. The method according to claim 22, wherein the wavelength separation between said separate wavelengths is at least 10 nm, in particular 30-100 nm, typically about 50 nm.

24. The method according to claim 22 or 23, wherein the separate wavelengths are chosen from different sides of the peak value of the excitation or emission peak of the sample.

25-31. (canceled)
